(19) United States
(12) Patent Application Publication
(10) Pub. No.: US 2024/0335020 A1
(43) Pub. Date: Oct. 10, 2024

(54) HIGH-SPEED HAIR DRYER WITH LOW NOISE AND HIGH AIR PRESSURE

(71) Applicant: CHINA DRIVE MOTORS (SHENZHEN) CO., LTD., Shenzhen (CN)

(72) Inventors: Pingxian Zhong, Shenzhen (CN); Zhen Huang, Shenzhen (CN); Jingwen Cheng, Shenzhen (CN); Gangyao Kuang, Shenzhen (CN)

(21) Appl. No.: 18/404,914

(22) Filed: Jan. 5, 2024

(30) Foreign Application Priority Data
Apr. 7, 2023 (CN) 202310405254.0

(51) Int. Cl. A45D 20/12

(52) U.S. Cl. CPC A45D 20/12

(57) ABSTRACT

The present disclosure relates to the technical field of hair dryers, in particular to a high-speed hair dryer with low noise and high air pressure. According to the present disclosure, a sufficient air intake is provided by forming an air inlet structure with double air ducts and converging the two air ducts to an air duct fusion chamber for mutual complementation and fusion, thereby ensuring the stability of the air intake of a high-speed motor, improving the working efficiency of the high-speed motor, enabling the entire high-speed hair dryer to maintain air feeding and discharging of high air pressure and high air volume, and achieving the effect of noise reduction.

### CROSS REFERENCE TO RELATED APPLICATIONS

The present application claims the benefit of Chinese Patent Application No. 202310405254.0 filed on Apr. 7, 2023, the contents of which are incorporated herein by reference in their entirety.

### FIELD OF TECHNOLOGY

The present disclosure relates to the technical field of hair dryers, in particular to a high-speed hair dryer with low noise and high air pressure.

### BACKGROUND

The hair dryer is a commonly used household appliance. During use, an air barrel directly faces the head of a human body, and an air outlet is very close to the ears of a user. The air blown out by the air barrel makes a loud noise, causing discomfort to the ears of the user. Especially when a motor of a high-speed hair dryer continuously runs at an ultra-high speed, strong airflow is subjected to great pressure in a chamber of an air barrel of the hair dryer, and the entire main air duct is not smooth enough, such that stray air is produced. The stray air collides with a barrier part of the chamber under high pressure to produce noise and abnormal sound, which has a greater impact on the user.

In addition to the impact of noise, the stability of air pressure and air volume of outlet air is also a factor that affects the usage experience. Especially for the high-speed hair dryer, a sudden increase or decrease in air intake directly affects the air pressure and air volume of the outlet air, which makes the user obviously feel that the air volume is sometimes large and sometimes small, resulting in bad usage experience. A conventional hair dryer generally adopts an air inlet structure with single air duct. When the air intake of the single air duct is unsteady, the air pressure and air volume of the outlet air of the hair dryer are directly affected. Moreover, the working efficiency of a high-speed motor is reduced in the case of the decreased air intake, and working in an unsteady airflow environment for a long time will shorten the service life of a high-speed fan. The unsteadiness of the air volume of inlet air and outlet air will change the frequency and amplitude of sound propagation to generate a new noise source.

Therefore, how to ensure the steadiness of the air pressure and air volume of the hair dryer, improve the working efficiency of the high-speed motor, and reduce air noise through reasonable air duct design has become a problem that needs to be solved for the high-speed hair dryer.

### SUMMARY

The present disclosure provides a high-speed hair dryer with low noise and high air pressure, to overcome the deficiencies of an existing high-speed hair dryer.

The present disclosure provides a high-speed hair dryer with low noise and high air pressure, including an air barrel, a handle, and a high-speed motor, where the air barrel is provided with an air outlet, a first air inlet, a second air inlet, and an air duct fusion chamber, a first air duct is formed at the first air inlet, the handle is provided with a handle air inlet, the handle is connected to the second air inlet of the air barrel to form a second air duct, the first air duct and the second air duct converge in the air duct fusion chamber, and the high-speed motor is arranged between the air outlet and the air duct fusion chamber.

As a further improvement of the present disclosure, the air barrel includes an air barrel inlet assembly and an air barrel outlet assembly, the air barrel outlet assembly is arranged at the air outlet of the air barrel, the air barrel inlet assembly is connected to the first air inlet of the air barrel to form the first air duct, and the high-speed motor is arranged between the air barrel outlet assembly and the air duct fusion chamber.

As a further improvement of the present disclosure, the air barrel inlet assembly includes an air inlet rear cover and a double-air-duct structural member, the air inlet rear cover is connected to the double-air-duct structural member to form the air duct fusion chamber, the air inlet rear cover is provided with a rear cover air inlet, the rear cover air inlet communicates with the air duct fusion chamber to form the first air duct, a main air inlet and auxiliary air inlets are provided in a middle and side edges of the double-air-duct structural member respectively, the handle air inlet, the second air inlet, the auxiliary air inlets, and the air duct fusion chamber communicate to form the second air duct, and the main air inlet is in butt joint with an air inlet of the high-speed motor.

As a further improvement of the present disclosure, the air barrel inlet assembly further includes a trapezoidal filter net, the double-air-duct structural member is provided with a first filter net groove, the first filter net groove is located on outer edges of the auxiliary air inlets, the trapezoidal filter net has a bottom connected into the first filter net groove and a top connected to the air inlet rear cover, the air inlet rear cover forms an air inlet buffer area with an inclined surface of the trapezoidal filter net, and the rear cover air inlet communicates with the air inlet buffer area.

As a further improvement of the present disclosure, the rear cover air inlet is annularly arranged on a side wall of the air inlet rear cover and is of a grid type porous air inlet structure.

As a further improvement of the present disclosure, the air barrel inlet assembly further includes a light emitting assembly, a light emitting groove is provided in a middle of the air inlet rear cover, the light emitting assembly includes a semi-transparent light guide component, a nixie tube, and an adapter bracket connected in sequence, the semi-transparent light guide component is hermetically connected into the light emitting groove, a bottom of the semi-transparent light guide component is provided with a second filter net groove, and the top of the trapezoidal filter net is connected into the second filter net groove.

As a further improvement of the present disclosure, the air barrel outlet assembly includes a front housing, a rear housing, an air guide component provided with a circular arc boss, a heating wire, and an annular bracket, the front housing and the rear housing are fastened to form an air outlet chamber, the heating wire is arranged in the annular bracket, the air guide component is connected to a middle of the annular bracket, the heating wire is located at a lower air opening of the air guide component, the rear housing is provided with an annular air outlet, the annular bracket is connected into the air outlet chamber, the air outlet is aligned with the heating wire in position, the front housing is provided with a motor mounting groove, the motor mounting groove communicates with the air outlet chamber, and the high-speed motor is connected into the motor mounting groove.

As a further improvement of the present disclosure, a top of a cavity wall of the front housing is higher than a bottom outlet of the motor mounting groove, to form an inner groove facing away from an air direction.

As a further improvement of the present disclosure, the high-speed hair dryer with low noise and high air pressure further includes a motor buffer pad, the motor buffer pad is sleeved outside the high-speed motor, and an outer surface of the motor buffer pad is provided with bumps increasing the roughness and is attached to an inner side surface of the motor mounting groove.

As a further improvement of the present disclosure, the handle includes a handle housing, an air inlet tail cover, a handle filter net, a printed circuit board (PCB), and a silencer net, the handle housing is internally provided with a handle air duct chamber, the PCB and the silencer net are arranged in the handle air duct chamber, the air inlet tail cover is provided with the handle air inlet, the handle filter net is connected to one end of the handle housing, the air inlet tail cover is connected to the other end of an inner housing and covers the filter net, the other end of the handle housing is connected to the air barrel, and the handle air inlet communicates with the handle air duct chamber.

The present disclosure has the following beneficial effects:

(1) A sufficient air intake is provided by forming an air inlet structure with double air ducts by the air barrel inlet assembly and the handle with the air inlet and converging the two air ducts to the air duct fusion chamber for mutual complementation and fusion, thereby ensuring the stability of the air intake of the high-speed motor, improving the working efficiency of the high-speed motor, and enabling the entire high-speed hair dryer to maintain air feeding and discharging of high air pressure and high air volume.

(2) Two airflows in different directions converge in the air duct fusion chamber from different angles, and sound waves formed by air in two air directions cancel each other, thereby achieving the effect of noise reduction; moreover, in the case of sufficient air volume, the high-speed motor will not be idling, and air noise generated by the high-speed motor due to unsteady airflows is reduced, thereby achieving the effect of overall noise reduction.

### BRIEF DESCRIPTION OF THE DRAWINGS

FIG. 1 is a diagram of an overall structure of a high-speed hair dryer with low noise and high air pressure according to the present disclosure;

FIG. 2 is an exploded view of a structure of a high-speed hair dryer with low noise and high air pressure according to the present disclosure;

FIG. 3 is a sectional view of a structure of a high-speed hair dryer with low noise and high air pressure according to the present disclosure;

FIG. 4 is an exploded view of a structure of an air barrel inlet assembly in the present disclosure;

FIG. 5 is an exploded view of a structure of a handle in the present disclosure;

FIG. 6 is an exploded view of a structure of an air barrel outlet assembly in the present disclosure; and

FIG. 7 is a sectional view of a structure of a front housing in the present disclosure.

### DESCRIPTION OF THE EMBODIMENTS

To make the objective, the technical solutions and advantages of the present disclosure clearer, the present disclosure is further described in detail below in conjunction with the accompanying drawings and embodiments.

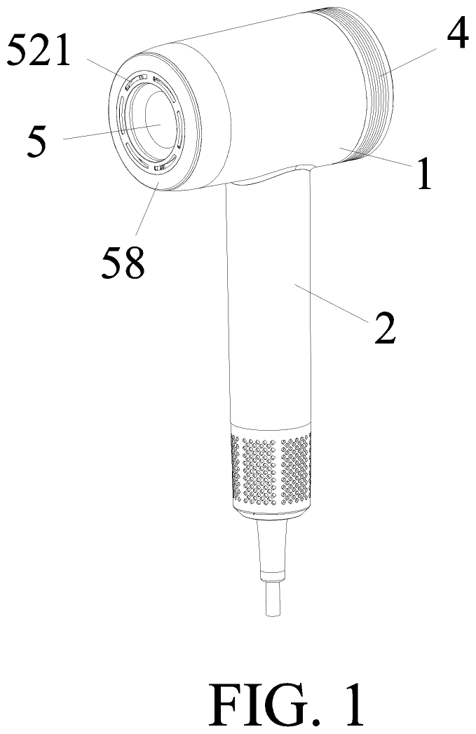

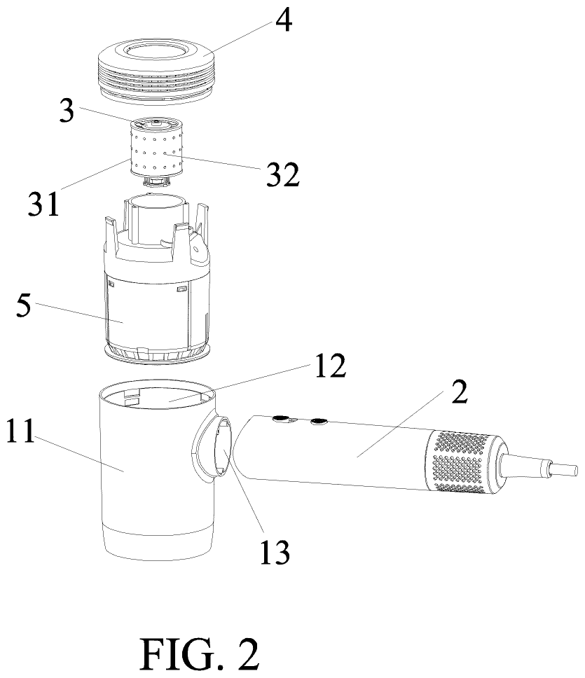

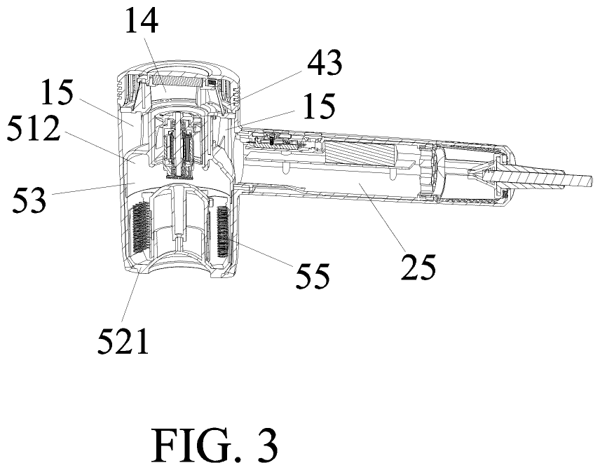

As shown in FIG. 1 to FIG. 3, a high-speed hair dryer with low noise and high air pressure according to the present disclosure includes an air barrel 1, a handle 2, and a high-speed motor 3, where the air barrel 1 is provided with an air outlet, a first air inlet 12, a second air inlet 13, and an air duct fusion chamber 14, a first air duct is formed at the first air inlet 12, the handle 2 is provided with a handle air inlet 221, the handle 2 is connected to the second air inlet 13 of the air barrel 1 to form a second air duct, the first air duct and the second air duct converge in the air duct fusion chamber 14, and the high-speed motor 3 is arranged between the air outlet and the air duct fusion chamber 14.

The high-speed hair dryer according to the present disclosure is provided with two air inlet structures, namely the air barrel 1 and the handle 2, thereby increasing air volume of inlet air, ensuring sufficient air supply, improving the working efficiency of the high-speed motor 3, making the entire hair dryer have the characteristics of high air pressure and high air volume, and reducing noise generated by the high-speed motor 3 in the case of unsteady air volume. Through the arrangement of the air duct fusion chamber 14, airflows of the two air ducts are concentrated and fused, and sound waves generated by the two airflows in different directions partially cancel each other to reduce the noise of the inlet air.

The air barrel 1 includes an air barrel inlet assembly 4 and an air barrel outlet assembly 5, the air barrel outlet assembly 5 is arranged at the air outlet of the air barrel 1, the air barrel inlet assembly 4 is connected to the first air inlet 12 of the air barrel 1 to form the first air duct, and the high-speed motor 3 is arranged between the air barrel outlet assembly 5 and the air duct fusion chamber 14.

A structure of the air barrel inlet assembly 4 cooperates with a structure of the handle air inlet 221 of the handle 2 to form an air inlet structure with double air ducts, thereby ensuring the stability of an air intake. The reasonable air duct design inside the air barrel outlet assembly 5 ensures the stability of air volume of outlet air. A silencer structure is added to the handle 2, and noise reduction design is made at multiple positions where the airflows flow through, such as the air inlet, the first air inlet 12, the second air inlet 13, and the air duct fusion chamber 14, thereby making the entire hair dryer have the characteristic of low noise.

The air barrel 1 further includes an air barrel housing 11, the air outlet, the first air inlet 12, and the second air inlet 13 are arranged on the air barrel housing 11, the air barrel outlet assembly 5 is connected into the air barrel housing 1 and is located at the air outlet, the air barrel inlet assembly 4 is in butt joint with the first air inlet 12 of the air barrel housing 11, and the handle 2 is in butt joint with the second air inlet 13 of the air barrel housing 11.

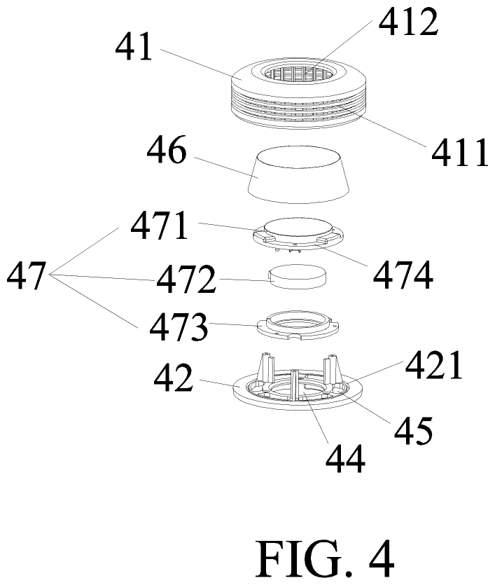

As shown in FIG. 4, the air barrel inlet assembly 4 includes an air inlet rear cover 41 and a double-air-duct structural member 42, the air inlet rear cover 41 is connected to the double-air-duct structural member 42 to form the air duct fusion chamber 14, the air inlet rear cover 41 is provided with a rear cover air inlet 411, the rear cover air inlet 411 communicates with the air duct fusion chamber 14 to form the first air duct, a main air inlet 44 and auxiliary air inlets 45 are provided in a middle and side edges of the double-air-duct structural member 42 respectively, the handle air inlet 221, the second air inlet 13, the auxiliary air inlets 45, and the air duct fusion chamber 14 communicate to form the second air duct, and the main air inlet 44 is in butt joint with an air inlet of the high-speed motor 3.

The airflow from the first air duct directly enters the air duct fusion chamber 14, and the airflow from the second air duct enters the air duct fusion chamber 14 through the auxiliary air inlets 45. After converging, the airflows enter the high-speed motor 3 from the main air inlet 44 in a concentrated manner. The double-air-duct structural member 42 makes the hair dryer have double air ducts, which increases the air intake and reduces the air noise of the inlet air.

A top of a front housing 51 of the air barrel outlet assembly 5 is provided with an inclined surface, which provides an airflow channel 15 between the second air inlet 13 and the auxiliary air inlets 45 of the double-air-duct structural member 42, allowing the inlet airflow of the handle 2 to smoothly flow into the air duct fusion chamber 14.

The air barrel inlet assembly 4 further includes a trapezoidal filter net 46, the double-air-duct structural member 42 is provided with a first filter net groove 421, the first filter net groove 421 is located on outer edges of the auxiliary air inlets 45, the trapezoidal filter net 46 has a bottom connected into the first filter net groove 421 and a top connected to the air inlet rear cover 41, the air inlet rear cover 41 forms an air inlet buffer area 43 with an inclined surface of the trapezoidal filter net 46, and the rear cover air inlet 411 communicates with the air inlet buffer area 43.

The air inlet buffer area 43 provides a transitional area for air introduced from the air inlet rear cover 41 before entering the filter net, which widens the air duct of the inlet air, thereby avoiding the situation that the filter net directly clings to the air inlet to cause the air duct of the inlet air to be narrow to generate the air noise. Additionally, the air inlet buffer area 43 forms an air container to ensure that sufficient air enters the trapezoidal filter net 46, thereby ensuring the stability of the air volume of the inlet air and improving the working efficiency of the high-speed motor 3. The trapezoidal filter net 46 is preferably made of a metal. The trapezoidal filter net 46 made of the metal has better toughness, is not easily deformed, and is resistant to high temperatures, making it suitable for use in electric hot air hair dryers.

The rear cover air inlet 411 is annularly arranged on a side wall of the air inlet rear cover 41 and is of a grid type porous air inlet structure. The use of the grid type porous air inlet structure may disperse the airflow of the inlet air as much as possible, and a main airflow is divided into airflows of multiple small air ducts to disperse the noise. Compared with the problem that high noise is generated when a concentrated airflow flows in, dispersing the airflow into the airflows of the multiple small air ducts takes the effect of noise reduction.

The air barrel inlet assembly 4 further includes a light emitting assembly 47, a light emitting groove 412 is provided in a middle of the air inlet rear cover 41, the light emitting assembly 47 includes a semi-transparent light guide component 471, a nixie tube 472, and an adapter bracket 473 connected in sequence, the semi-transparent light guide component 471 is hermetically connected into the light emitting groove 412, a bottom of the semi-transparent light guide component 471 is provided with a second filter net groove 474, and the top of the trapezoidal filter net 46 is connected into the second filter net groove 474.

The nixie tube 472 may display some electronic information of wire tubes or display some decorative lighting effects to beautify the entire product. The adapter bracket 473 has an effect of fixing the nixie tube 472 to the semi-transparent light guide component 471. The display effect of the nixie tube 472 may be seen through the semi-transparent light guide component 471. The semi-transparent light guide 471 serves as a sealing element to seal the middle of the air inlet rear cover 41, thereby avoiding air leakage in the middle of the air inlet rear cover 41 and preventing the air noise from coming out from the middle of the air inlet rear cover 41.

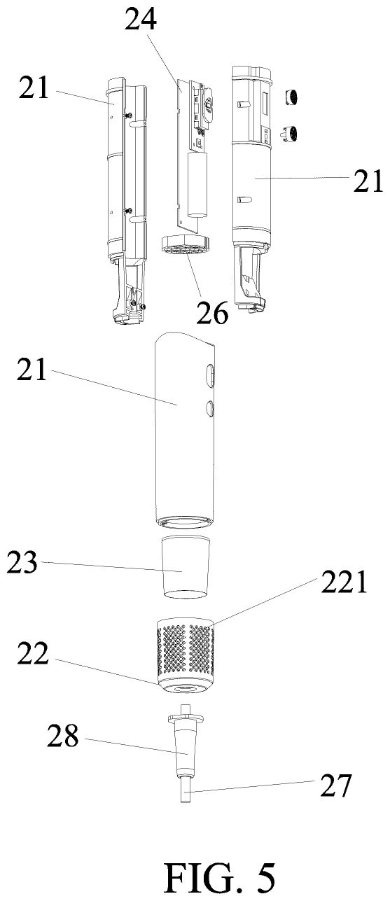

As shown in FIG. 5, the handle 2 includes a handle housing 21, an air inlet tail cover 22, a handle filter net 23, and a printed circuit board (PCB) 24, the handle housing 21 is internally provided with a handle air duct chamber 25, the PCB 24 is arranged in the handle air duct chamber 25, the air inlet tail cover 22 is provided with the handle air inlet 221, the handle filter net 23 is connected to one end of the handle housing 21, the air inlet tail cover 22 is connected to the other end of an inner housing and covers the filter net, the other end of the handle housing 21 is connected to the air barrel housing 11, and the handle air inlet 221 communicates with the handle air duct chamber 25.

When the air enters the handle 2, the airflow flows in through the annular handle air inlet 221 of the air inlet tail cover 22, is filtered by the handle filter net 23, directly enters the handle air duct chamber 25, and flows along the air duct into the air duct fusion chamber 14. The PCB 24 is located on the air duct of the airflow, such that the airflow which flows through the PCB performs heat dissipation on the PCB 24. The handle air inlet 221 may adopt a grid type porous structure to disperse the airflow so as to reduce the air noise. The handle filter net 23 may also adopt the trapezoidal filter net 46 of the air barrel inlet assembly 4, and the air inlet buffer area 43 is formed between the handle filter net and the air inlet tail cover 22 to widen a buffer area of the inlet air to ensure that the sufficient air enters the filter net, thereby ensuring the stability of the air volume of the inlet air at the handle 2.

The handle 2 includes a power wire 27 and a cable fastener 28, the power wire 27 is configured to be connected into the PCB 24 for power supply, and the cable fastener 28 fixes the power wire 27 to the handle housing 21 and protects the power wire 27.

The handle 2 further includes a silencer net 26 arranged in the handle air duct chamber 25. At the air inlet, noise may be generated due to collision between the airflow and a side wall of the inner housing. The air noise at the air inlet of the handle 2 may be reduced by fixing the silencer net 26 to the air inlet.

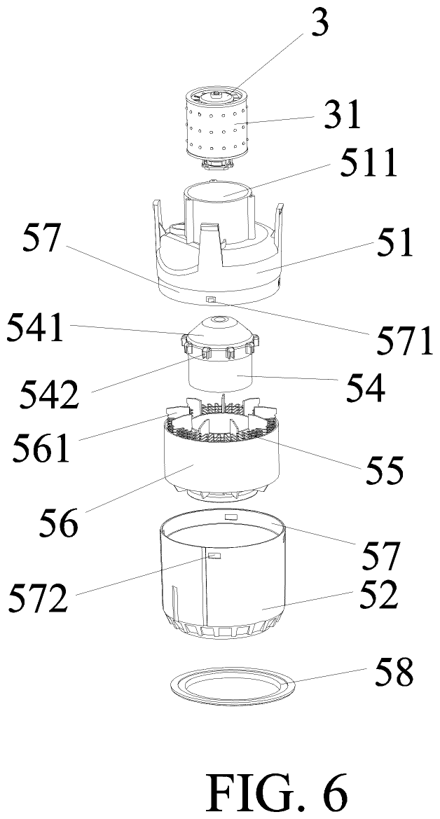

As shown in FIG. 6, the air barrel outlet assembly 5 includes a front housing 51, a rear housing 52, an air guide component 54 provided with a circular arc boss 541, a heating wire 55, and an annular bracket 56, the front housing 51 and the rear housing 52 are fastened to form an air outlet chamber 53, the heating wire 55 is arranged in the annular bracket 56, the air guide component 54 is connected to a middle of the annular bracket 56, the heating wire 55 is located at a lower air opening of the air guide component 54, the rear housing 52 is provided with an annular air outlet 521, the annular bracket 56 is connected into the air outlet chamber 53, the air outlet 521 is aligned with the heating wire 55 in position, the front housing 51 is provided with a motor mounting groove 511, the motor mounting groove 511 communicates with the air outlet chamber 53, and the high-speed motor 3 is connected into the motor mounting groove 511.

The air guide component 54 is located at a lower air opening of the high-speed motor 3. A structure of the circular arc boss 541 of the air guide component 54 guides the high-speed motor 3 to discharge air from two sides, and the air flows into the annular heating wire 55 for hot air heating, thereby avoiding the situation that the airflow forms a turbulent flow in the middle of the annular bracket 56, making the flow of the air duct smoother, and greatly reducing the air noise.

The air guide component 54 is fixed to mica sheets 561 of the annular bracket 56 through corresponding clamping grooves 542, and an outer wall of the annular bracket 56 is also fixed inside the rear housing 52 through corresponding clamping grooves. A lower edge of the front housing 51 and an upper edge of the rear housing 52 are both provided with stop edges 57, and the stop edges 57 are correspondingly provided with hooks 571 and clamping grooves 572. The stop edges of the front housing 51 and the rear housing 52 are butted in a mutually staggered manner and are fixedly butted through the hooks 571 and the clamping grooves 572. A gap at a joint between the front housing 51 and the rear housing 52 may be sealed through the stop edges 57. The front housing 51 and rear housing 52 are both integrated parts. A circle of raised stop edge 57 is connected to fasteners to form a sealed structure for eliminating the possibility of noise leakage. There are the heating wire 55 and the air guide component 54 inside, which greatly reduces the generation of the air noise.

The heating wire 55 is annularly distributed. In cooperation with a structure of the annular air outlet 521 on the rear housing 52, the air subjected to flow division is dispersed and heated before being sent out. The entire air duct of outlet air forms an air outlet surface, making the air softer when acting on the head of a user without giving the user a feeling of being directly blown in a concentrated manner by strong air, and improving the user experience. A decorative ring 58 may be added to a bottom of the rear housing 52 to improve the attractiveness of the air outlet.

The high-speed motor 3 may be directly mounted in the motor mounting groove 511, and the double-air-duct structural member 42 is fixed to the motor mounting groove 511 of the front housing 51 through screws to clamp an edge of the high-speed motor 3, thereby preventing the high-speed motor 3 from falling off from the motor mounting groove 511 in the case of ensuring that the air inlet is not blocked.

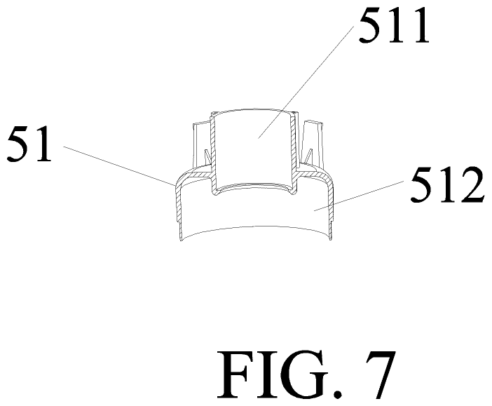

As shown in FIG. 7, a top of a cavity wall of the front housing 51 is higher than a bottom outlet of the motor mounting groove 511 to form an inner groove 512 facing away from an air direction. The design of the inner groove 512 in the front housing 51 increases the volume of the entire air outlet chamber. The inner groove 512 facing away from the air direction may serve as a buffer space for the airflow. When the air intake is insufficient, the airflow in the inner groove 512 may be used as a supplement to stabilize air pressure of the outlet air and reduce air noise formed by unsteady air pressure and air volume of the outlet air.

The high-speed hair dryer with low noise and high air pressure further includes a motor buffer pad 31, the motor buffer pad 31 is sleeved outside the high-speed motor 3, and an outer surface of the motor buffer pad 31 is provided with bumps 32 increasing the roughness and is attached to an inner side surface of the motor mounting groove 511. The motor buffer pad 31 is assembled between the high-speed motor 3 and the motor mounting groove 511 to play a buffering role, thereby preventing the high-speed motor 3 from directly hitting the front housing 51 to generate noise due to vibration during operation, and reducing the noise while protecting the high-speed motor 3. The bumps 32 on the outer surface of the motor buffer pad 31 may be more firmly attached to the inner side surface of the motor mounting groove 511, to avoid loosening and falling.

The working principle of the high-speed hair dryer with low noise and high air pressure is as follows:

When the high-speed motor 3 is running, a negative pressure is formed in the air duct fusion chamber 14, and air enters the air barrel inlet assembly 4 of the air duct fusion chamber 14 and the handle 2 simultaneously to form two air ducts to converge in the air duct fusion chamber 14. Due to different flow directions of airflows of the two air ducts, noise waves generated by the two airflows will affect each other and partially cancel during convergence to reduce the noise.

An air inlet process for the first air duct is as follows: outside air flows into the air inlet buffer area 43 between the trapezoidal filter net 46 and the air inlet rear cover 41 through the annular rear cover air inlet 411 of the air inlet rear cover 41. Apart of airflow enters the air duct fusion chamber 14 along filtering holes on the inclined surface of the trapezoidal filter net 465 and enters the high-speed motor 3 through the main air inlet 44 of the double-air-duct structural member 42. Because the air direction of the airflow entering the trapezoidal filter net 46 is perpendicular to or at a certain angle relative to the air direction of the airflow entering the air inlet rear cover 41, the noise waves generated by the airflows in two directions will affect each other and partially cancel to reduce the air noise. The other part of airflow is temporarily buffered in the air inlet buffer area 43 to serve as a supplement of air volume to ensure the stability of the air intake. Even if the airflow entering from the air inlet rear cover 41 is suddenly reduced, the airflow in the air inlet buffer area 43 may also be used as a supplement of inlet air, without immediately affecting the air intake at the air barrel inlet assembly 4.

An air inlet process for the second air duct is as follows: outdoor airflow enters from the annular handle air inlet 221 of the air inlet tail cover 224, is filtered by the handle filter net 23, enters the handle air duct chamber 25, flows into the second air inlet 13 of the air barrel 1 along the handle air duct chamber 25, and enters the air duct fusion chamber 14 from the auxiliary air inlets 45 of the double-air-duct structural member 42 to converge with the airflow in the first air duct. In this process, the airflow in the handle air duct chamber 25 cools the PCB 24, and the airflow entering the air duct chamber is subjected to noise reduction by the silencer net 26, thereby achieving the effect of low noise while ensuring air feeding at the handle 2.

The air in the air duct fusion chamber 14 is conveyed to the air outlet chamber 53 through rotation of the high-speed motor 3. Under the guidance of the circular arc boss 541 of the air guide component 54, the air duct in the high-speed motor 3 is divided into multiple side air ducts to enter an annular heating groove. The air is heated by the heating wire 55 and blown out from the annular air outlet 521 of the rear housing 52. The arrangement of the circular arc boss 541 of the air guide component 54 ensures that the outlet air from the high-speed motor 3 is smoothly guided to the heating wire 55, without forming a turbulent flow in a middle of the heating groove to generate noise, thereby reducing the noise. Moreover, some air of the high-speed motor 3 is buffered in the inner groove 512 of the front housing 51, making the entire air outlet chamber 53 serve as a space filled up with the airflow. When the air intake is sufficient, the air is directly heated by the heating wire 55 and then is directly blown out. When the air intake is suddenly reduced, the airflow in the inner groove 512 may be fused with the inlet air and is blown out after being heated, such that the air barrel outlet assembly 5 ensures the stability of air volume and air pressure of the outlet air, the problem that the air volume is sometimes large and sometimes small is avoided, the impact of unsteady air volume on noise at the air outlet is reduced, and the user experience is improved.

The above content is a further detailed explanation of the present disclosure in conjunction with specific preferred embodiments, and it cannot be considered that specific implementation of the present disclosure is only limited to these explanations. Several simple deductions or substitutions may also be made by those of ordinary skill in the art to which the present disclosure belongs without departing from the conception of the present disclosure, and all should fall within the scope of protection of the present disclosure.

What is claimed is:

1. A high-speed hair dryer with low noise and high air pressure, comprising an air barrel, a handle, and a high-speed motor, wherein the air barrel is provided with an air outlet, a first air inlet, a second air inlet, and an air duct fusion chamber, a first air duct is formed at the first air inlet, the handle is provided with a handle air inlet, the handle is connected to the second air inlet of the air barrel to form a second air duct, the first air duct and the second air duct converge in the air duct fusion chamber, and the high-speed motor is arranged between the air outlet and the air duct fusion chamber.

2. The high-speed hair dryer with low noise and high air pressure according to claim 1, wherein the air barrel comprises an air barrel inlet assembly and an air barrel outlet assembly, the air barrel outlet assembly is arranged at the air outlet of the air barrel, the air barrel inlet assembly is connected to the first air inlet of the air barrel to form the first air duct, and the high-speed motor is arranged between the air barrel outlet assembly and the air duct fusion chamber.

3. The high-speed hair dryer with low noise and high air pressure according to claim 2, wherein the air barrel inlet assembly comprises an air inlet rear cover and a double-air-duct structural member, the air inlet rear cover is connected to the double-air-duct structural member to form the air duct fusion chamber, the air inlet rear cover is provided with a rear cover air inlet, the rear cover air inlet communicates with the air duct fusion chamber to form the first air duct, a main air inlet and auxiliary air inlets are provided in a middle and side edges of the double-air-duct structural member respectively, the handle air inlet, the second air inlet, the auxiliary air inlets, and the air duct fusion chamber communicate to form the second air duct, and the main air inlet is in butt joint with an air inlet of the high-speed motor.

4. The high-speed hair dryer with low noise and high air pressure according to claim 3, wherein the air barrel inlet assembly further comprises a trapezoidal filter net, the double-air-duct structural member is provided with a first filter net groove, the first filter net groove is located on outer edges of the auxiliary air inlets, the trapezoidal filter net has a bottom connected into the first filter net groove and a top connected to the air inlet rear cover, the air inlet rear cover forms an air inlet buffer area with an inclined surface of the trapezoidal filter net, and the rear cover air inlet communicates with the air inlet buffer area.

5. The high-speed hair dryer with low noise and high air pressure according to claim 3, wherein the rear cover air inlet is annularly arranged on a side wall of the air inlet rear cover and is of a grid type porous air inlet structure.

6. The high-speed hair dryer with low noise and high air pressure according to claim 3, wherein the air barrel inlet assembly further comprises a light emitting assembly, a light emitting groove is provided in a middle of the air inlet rear cover, the light emitting assembly comprises a semi-transparent light guide component, a nixie tube, and an adapter bracket connected in sequence, the semi-transparent light guide component is hermetically connected into the light emitting groove, a bottom of the semi-transparent light guide component is provided with a second filter net groove, and the top of the trapezoidal filter net is connected into the second filter net groove.

7. The high-speed hair dryer with low noise and high air pressure according to claim 2, wherein the air barrel outlet assembly comprises a front housing, a rear housing, an air guide component provided with a circular arc boss, a heating wire, and an annular bracket, the front housing and the rear housing are fastened to form an air outlet chamber, the heating wire is arranged in the annular bracket, the air guide component is connected to a middle of the annular bracket, the heating wire is located at a lower air opening of the air guide component, the rear housing is provided with an annular air outlet, the annular bracket is connected into the air outlet chamber, the air outlet is aligned with the heating wire in position, the front housing is provided with a motor mounting groove, the motor mounting groove communicates with the air outlet chamber, and the high-speed motor is connected into the motor mounting groove.

8. The high-speed hair dryer with low noise and high air pressure according to claim 7, wherein a top of a cavity wall of the front housing is higher than a bottom outlet of the motor mounting groove, to form an inner groove facing away from an air direction.

9. The high-speed hair dryer with low noise and high air pressure according to claim 7, further comprising a motor buffer pad, wherein the motor buffer pad is sleeved outside the high-speed motor, and an outer surface of the motor buffer pad is provided with bumps increasing the roughness and is attached to an inner side surface of the motor mounting groove.

10. The high-speed hair dryer with low noise and high air pressure according to claim 1, wherein the handle comprises a handle housing, an air inlet tail cover, a handle filter net, a printed circuit board (PCB), and a silencer net, the handle housing is internally provided with a handle air duct chamber, the PCB and the silencer net are arranged in the handle air duct chamber, the air inlet tail cover is provided with the handle air inlet, the handle filter net is connected to one end of the handle housing, the air inlet tail cover is connected to the other end of an inner housing and covers the filter net, the other end of the handle housing is connected to the air barrel, and the handle air inlet communicates with the handle air duct chamber.
